(19) United States
(12) Patent Application Publication
(10) Pub. No.: US 2019/0298605 A1
(43) Pub. Date: Oct. 3, 2019

(54) METHOD AND DEVICE FOR MITIGATING A HEALTH-RELATED CONDITION

(71) Applicants: John Rabolt, Newark, DE (US); Ingrid Pretzer-Aboff, Newark, DE (US); Richard Martin, Newark, DE (US); Bruce Chase, Newark, DE (US); Scott Jones, Newark, DE (US)

(72) Inventors: John Rabolt, Newark, DE (US); Ingrid Pretzer-Aboff, Newark, DE (US); Richard Martin, Newark, DE (US); Bruce Chase, Newark, DE (US); Scott Jones, Newark, DE (US)

(73) Assignee: University of Delaware, Newark, DE (US)

(21) Appl. No.: 16/374,090

(22) Filed: Apr. 3, 2019

Related U.S. Application Data
(60) Provisional application No. 62/651,751, filed on Apr. 3, 2018.

(51) Int. Cl. A61H 23/02

(52) U.S. Cl. CPC A61H 23/0245; A61H 23/02; A61H 2230/605; A61H 2201/1638; A61H 2201/165; A61H 2201/5097; A61H 2201/501; A61H 2201/0157; A61H 2201/5058

(57) ABSTRACT

A method for mitigating an involuntary muscle movement in a patient by applying external vibration in multiple locations distributed about a periphery of an upper arm or forearm of the patient for an applied vibration duration that is less than the efficacy duration. Applied vibration duration as a percentage of efficacy duration is ideally less than 80%. A wearable device for performing the method has a flexible base for removably affixing to a patient's upper arm or forearm, a plurality of vibration generators, a power source, and a connected microcontroller configured to control the vibration generated by the vibration generators in accordance with a pulse frequency. The microcontroller is configured to connect to a remote controller via a communications interface. The vibration generators have a nominal vibration frequency different from the pulse frequency.

### CROSS REFERENCE TO RELATED APPLICATIONS

This application claims priority to U.S. Provisional Patent Application Ser. No. 62/651,751, filed Apr. 3, 2018, incorporated herein by reference in its entirety.

### BACKGROUND OF THE INVENTION

Parkinson's disease slowly isolates patients by decreasing mobility and disrupting fine motor control. Unfortunately, even after several decades of research, there is still no cure or therapeutic option to slow the disease. The major treatment strategies historically employed for Parkinson's Disease (PD) have been pharmaceutical or surgical. Pharmaceutical therapies comprise primarily dopamine replacement therapies. Dopamine replacement therapy is convenient, accessible and affordable. Orally administered Levodopa, the drug, replaces the neurotransmitter dopamine in the PD patient's brain. However, the side effects include dyskinesia (excessive movement) which can be just as disabling as the PD symptoms themselves. Nausea, orthostasis (severe drop in blood pressure when standing), hallucinations and confusion are additional disabling side effects of the drug. Typical costs for Levadopa treatment are about $2500 per year.

While a variety of medicines exist on the market to subdue and control some symptoms, specifically tremors, muscle rigidity and slowness of movement, most are known to only decrease the symptoms for a limited amount of time. Eventually, people with Parkinson's typically need to take increasingly more medication to relieve symptoms.

For more severe cases, for patients whose medicine intake is high, and/or who suffer disabling dyskinesia, Deep Brain Stimulation (DBS), a surgical procedure can be performed to reduce symptoms. DBS is not a guaranteed solution and has many risks; therefore, it is only used in very serious cases. DBS is an invasive surgical method that implants a neuro-stimulator and generates electrical impulses to specific areas in the brain. It is effective for most PD motor symptoms such as tremors. However, DBS surgery puts the patient at risk for surgical complications such as bleeding, infections, strokes and death. Residual effects from DBS lead placement can include speech problems, seizures, numbness, and balance issues. In addition, approximately 60% of people with PD are cognitively impaired, and as such are not candidates for DBS surgery. Costs of DBS surgery are in excess of $100,000.

There are also assistive devices on the market that can counteract the tremor but these are limited. A survey of the assistive devices for PD patients reveals an array of helpful, thoughtfully designed tools to aid patients with everything from eating to writing. While these are mainly focused on counteracting the effects of tremors, other manufacturers market basic assistive walking tools, including canes, walkers, and other medical walking aids, that might also be used by patients needing ambulatory assistance.

From a treatment perspective, however, historically there have only been two options: medicinal intervention and DBS. Hence, there remains a technological gap and a need for treatment therapies that are noninvasive, convenient and available at home, without the side effects of medicine or surgery, to bridge that gap.

### SUMMARY OF THE INVENTION

One aspect of the invention comprises a method for mitigating an involuntary muscle movement in a limb of a patient. The method comprises mitigating the involuntary muscle movement for an efficacy duration by applying external vibration in multiple locations distributed about a periphery of an upper arm or forearm of the patient, such as on the upper arm at least 1 inch above an elbow, for an applied vibration duration that is less than the efficacy duration. The step of applying the external vibration may comprise providing a vibration having a vibration frequency pulsed at a pulse frequency, wherein the ratio of vibration frequency to pulse frequency is in a range of 0.65-4.5, preferably in a range of 0.8-3, and more preferably in a range of 0.9 to 2. The vibration may be applied for duration as a percentage of efficacy duration of less than 80%. The method may comprise applying the vibration, discontinuing vibration while monitoring for signs of a return of involuntary muscle movement in the limb, detecting a return of the involuntary muscle movement, and again applying the vibration.

The step of applying the external vibration may comprise providing a wearable device having a plurality of vibration generators mounted thereon, the method comprising removably affixing the device to the upper arm or forearm of the patient such that the device transmits radial compression to the arm of the patient. The radial compression transmitted by the wearable device, a characteristic of the vibration, or the second duration may be varied during performance of the method. The wearable device may comprise a power source connected to the plurality of vibration generators, a microcontroller configured to control one or more vibration characteristics of the vibration generators, including pulse frequency, and a communications interface configured to be paired with a remote device for receiving externally communicated control settings for controlling the wearable device. The wearable device may comprise an inertial sensor configured to detect the involuntary muscle movement and to provide a signal to the microcontroller, wherein the microcontroller is programmed to energize the plurality of vibration generators for the applied vibration duration and to de-energize the plurality of vibration generators until the inertial sensor provides the signal to the microcontroller signifying detection of the involuntary muscle movement.

Another aspect of the invention comprises a wearable device for mitigating an involuntary muscle movement in limb of a patient. In an exemplary embodiment, the device comprises a flexible base configured to be removably affixed to an upper arm or forearm of the patient and configured to transmit a radial compressive force to the upper arm or forearm of the patient when affixed thereto. A plurality of vibration generators are mounted on or in the base. A microcontroller connected to a power source is configured to control one or more characteristics of a vibration generated by the vibration generators, including causing at least selected vibration generators to pulse on and pulse off at a pulse frequency for an applied vibration duration and to discontinue pulsing on and off for a resting duration, the applied vibration and the resting duration together defining an efficacy duration. A communications interface configured to facilitate a connection between the microcontroller and a remote controller for providing signals to the microcontroller.

The wearable device may include a wire configured to connect the device to a power source external to the device, or may include a portable power source integral to the wearable device, such as a battery and/or solar cells. The power source is preferably rechargeable, and the wearable device further comprises an interface for charging the power source, and may further comprise a portable charger configured to connect to the interface and to an external power source for recharging the portable power source.

In some configurations, the base may be elastic and the compressive force may be an elastic reaction force generated by stretching the base beyond a resting state. In other configurations, the base may have an open configuration and a closed configuration, wherein the base has an adjustable periphery in the closed configuration, the base having a first connection interface on a first end configured to mate with a second connection interface on the second end, such as micro-hooks and micro-loops.

Each of the plurality of vibration generators may comprise a piezoelectric device, a motor, or a solenoid. The plurality of vibration generators may be distributed on a flexible substrate embedded in a flexible base. The plurality of vibration generators may be evenly distributed in fixed positions, wherein the microcontroller is configurable to pulse only certain selected vibration generators and not to pulse other vibration generators. The wearable device may further comprise an inertial sensor configured to sense involuntary muscle movements in the wearer's arm not caused by the wearable device, with the microprocessor configured to receive and interpret a signal from the inertial sensor and to initiate the vibration assembly in response to sensing such involuntary muscle movements. The vibration generators may have a nominal vibration frequency that is different than the pulse frequency, wherein the ratio of vibration frequency to pulse frequency is in a range of 0.65-4.5, more preferably in a range of 0.8-3, and most preferably in a range of 0.9 to 2.

The microprocessor may be configured to apply the vibration for a duration as a percentage of efficacy duration of less than 80%, or more preferably less than 50%.

Still another aspect of the invention comprises a system configured to control a wearable device as described herein and a remote controller configured to communicate with the communications interface of the wearable device. The remote controller may comprise a computer processor programmed with instructions for communicating with the communications interface of the wearable device, such as a smart phone or tablet computer, wherein the instructions comprise application software resident on the smart phone or tablet computer. In some embodiments, the system further comprises a central computer having a processor and associated memory and accessible over a global computer network (e.g. “in the cloud”), wherein the application software resident on the smart phone or tablet computer is configured to cause the smart phone or tablet computer to communicate with software resident on the central computer memory that is executable by the central computer processor.

The wearable device may be configured to collect data regarding operation of the wearable device, efficacy of the wearable device, and/or patient information, and may be configured to upload the collected data to the remote controller or to the central computer processor. The system may be configured to process and store the uploaded data using the remote controller, the central computer processor, or a combination thereof. The system may be configured to provide control settings to the microcontroller corresponding to optimized operating parameters calculated by the remote controller, the central computer processor, or a combination thereof based upon the uploaded data. The central computer processor may be configured with a machine learning algorithm for processing the uploaded data for the patient or for a plurality of patients and for calculating the optimized operating parameters using the machine learning algorithm.

Still other aspects of the invention comprise computer memories programmed with machine readable instructions for carrying out any of the method steps as described herein with a processor, including programmed memory located on the wearable device for execution by the microcontroller, programmed memory located on the remote controller for execution by a processor in the remote controller, or programmed memory located on the central computer for execution by the central computer. Still further aspects of the invention comprise devices comprising the programmed memories and processors as described in the foregoing, including the microprocessor, remote controllers such as smart phones or tablet computers, or computer servers.

### BRIEF DESCRIPTION OF THE DRAWINGS

FIG. 1 is a schematic block diagram of the components of an exemplary system embodiment.

FIG. 2 is a graph illustrating an exemplary vibration pattern of an exemplary embodiment of the invention.

FIG. 3 illustrates an exemplary vibration assembly of one embodiment of the invention.

FIG. 4A is a cross-sectional schematic diagram depicting an exemplary wearable device comprising the exemplary vibration assembly of FIG. 3.

FIG. 4B is a plan view schematic diagram of a front side of an exemplary wearable device of FIG. 4A.

FIG. 4C is a plan view schematic diagram of a back side of an exemplary wearable device of FIG. 4A.

### DETAILED DESCRIPTION OF THE INVENTION

Clinical trials of a vibratory feedback system and method, referred to as the PDShoe, developed at the University of Delaware's PD Clinic, which is described in more detail at U.S. Pat. No. 8,692,675 and is incorporated herein by reference, demonstrated significant improvements in patients experiencing gait disturbances, including shuffling, balance issues and freezing of gait (FoG). Patients involved in the clinical trial expressed interest in obtaining access outside the trial to the PDShoe or like technology for continued relief of symptoms. Efforts to evolve the PDShoe led to a surprising discovery that therapeutic vibration alone may have beneficial results for PD patients, as further discussed in the Examples detailed herein.

One aspect of the invention comprises providing a non-invasive medical intervention that stimulates the nervous system of a user (e.g. a PD patient) and mitigates symptoms, e.g., reduce tremors. One embodiment comprises a miniaturized vibratory device, optimally integrated into a wearable electronic device that can be worn for extended periods of time, depending on the extent of the PD person's symptoms. The optimal miniaturized device comprises a vibration generator, optimized for vibrational frequency and amplitude, and a power supply that can be worn by a patient in an optimized location on the body, without interfering with the patient's use of their limbs or other normal activities.

The methods and devices described herein are configured to optimize the intervention and mitigation of musculoskeletal, neurological, neurodegenerative or other health-related conditions that cause involuntary muscle movements (e.g., tics, tremors, spasms), by providing external stimulation to a body part. In one embodiment, vibratory stimulation is used to mitigate the involuntary muscle movements. Exemplary health-related conditions that may be mitigated by the devices and methods as described herein include, without limitation: migraine headaches; sleep apnea; asthma; muscle pain; multiple sclerosis; chronic non-specific neck pain; dystonia; muscle spasms; cerebral palsy; blepharospasm; tremors or tics; muscle tightness or tightening; paralysis; parathesia; trigeminal neuralgia; phantom limb pain; Parkinson's Disease (PD); PD tremors in limbs or jaw; essential tremors; muscle tics; tic douloureux; abnormal or decreased proprioception; neuropathy.

In preferred embodiments, vibration used to treat the musculoskeletal, neurological, neurodegenerative or other health-related conditions is provided at a frequency between 0-200 Hz. Stimulation (e.g. vibration) may be provided to an extremity (e.g., arm, leg, etc.). In particular, a stimulation device may be placed on a patient's arm above the elbow.

An exemplary device comprises a power source, a source of stimulation powered by the power source, a control circuit to adjust amplitude and frequency of the stimulation, an on-off switch that controls power, and a radio frequency transceiver (e.g. operable to establish a Bluetooth connection) for external communication and programming of the device using a user interface in communication with the device. The power source may be tethered (i.e. connected via a wire) or untethered. In one embodiment, the power source may include a power cord plugged into a source of Alternating Current (AC). In another embodiment, the power source may comprise a source of DC power, such as a battery. A battery power source is preferably rechargeable via a recharging source, such as via a solar panel or a portable charger, which portable charger may be an external battery, a charger configured to connect to an electrical outlet (such as an AC outlet, a vehicle charge port, or via a USB port configured for use with any of the foregoing or with other USB-compatible sources of power (e.g. a personal computer).

The source of stimulation may comprise any type of device capable of producing tactile stimulation (e.g. vibration), including but not limited to a motor, piezoelectric device, or solenoid. Suitable vibration-producing motors may include any type of motor used in the manufacture of cell phones for providing haptic or tactile stimulation. One type of suitable motor, without limitation, is an eccentric rotating mass vibration motor (ERM), which uses a small unbalanced mass or eccentric weight on a DC motor, that creates a centrifugal force that translates to vibrations when the motor turns. Another type of suitable motor is a linear vibration motor, which comprises a moving mass attached to a wave spring, which creates a force when driven. A suitable control circuit may contain a frequency generator, a voltage controller, and a regulator.

The methods and devices for providing the stimulation may involve holding the source of electrical stimulation in intimate contact with the patient's body using external pressure, such as may be produced by a cuff or band, such as an elastic band (e.g. a rubber band) that exerts a compressive radial force on a limb of a patient. The elastic band may be configurable to have an adjustable diameter (e.g. a linear strip having mating micro-loop/micro-hook (such as Velcro® brand) connectors on opposite ends and configured to be mated together to cause the strip to form a closed loop). In some embodiments, the device may be integrated into a piece of clothing, such as a shirt sleeve or a pants leg. In other embodiments, contact between the stimulation source and the body may be produced by adhesion.

Exemplary stimulation devices may be configured to be varied in location on a patient's body, and exemplary methods may comprise optimizing location on the body for an individual patient.

Thus, one method for mitigating a Parkinson's Disease symptom, comprises attaching a plurality of vibrators to a circuit that includes a frequency generator and vibration amplitude controller, placing the vibrators in contact with the body of Parkinson's patient using external pressure. Vibration amplitude may be kept constant while changing frequency within a predetermined range of frequencies, such as in a range of 0-200 Hz or between the minimum and maximum of the rated frequency response range of the vibrator. The frequency may varied by pulsing a vibrator having a fixed nominal vibration frequency at a pulse frequency. The amplitude and/or fixed nominal vibration frequency of the vibrator may be varied while keeping a pulse frequency constant. The vibrators may be pulsed on/off for an applied vibration duration and then allowed to rest for a resting duration. Controlling, varying, or modifying any of the foregoing parameters may be referred to as a controlling, varying, or modifying of a vibration characteristic of the vibrators. The amount of external pressure applied to keep the vibrators in contact with the body may also be varied. The placement of the vibrators in contact with the body may be varied in location. Through variation of the foregoing variables, operating parameters may be determined that are optimal for a particular patient, a particular condition, or a combination thereof.

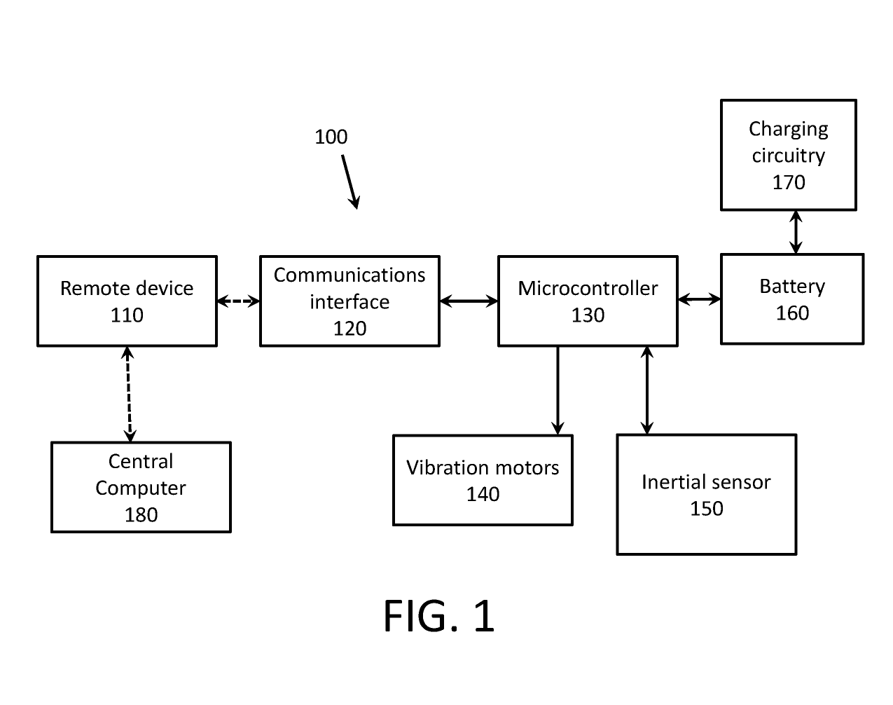

Referring now to the figures, FIG. 1 depicts an exemplary system 100 according to one embodiment of the invention. A microcontroller 130 is attached to a power source, such as a battery 160, such as a rechargeable lithium polymer battery. The battery is further connected to charging circuitry 170 that enables recharging of the battery via connection to a source of electrical power, such as via a USB interface (not shown) as are well known in the art for recharging mobile devices, including but not limited to wearable devices, to an electrical socket, a portable battery charger, or a computer system. The USB interface may also be configured to permit connection to a computer for downloading of new software or uploading of stored data. The microcontroller is configured to control vibration motors 140, which may be “coin cell” or piezo vibration motors embedded in a band, as described herein later, and to monitor data from an inertial sensor 150. The inertial sensor may comprise an accelerometer and/or gyroscope sensor configured to sense involuntary muscle movements and actively control the vibration system when such involuntary muscle movements occur. Microcontroller 130 is also connected to a communications interface 120, preferably a wireless interface (e.g. Wi-Fi or Bluetooth®) configured to allow the microcontroller to be in communication with a remote device 110, such as a computer (e.g. desktop or laptop) via Wi-Fi, or a mobile device (e.g. tablet computer or smart phone) via Bluetooth®, or any other wireless communications platform suitable for pairing the wearable unit to a user interface configured on a remote device. The system is not limited to any particular type of wireless communication protocol. The term “remote” as used herein refers to a device that is not integral to the wearable device, but is connectable via wired or wireless connection thereto. The microprocessor is configured to communicate with the remote controller to receive input signals such as control settings, as well as to communicate or upload information to the remote controller. Thus, a user may be able to most easily control the wearable device by using an interface on the remote controller, such as a smart phone app.

Although preferably a wireless communications interface, it should be understood that the communications interface 120 may instead or in addition provide a wired connection such as from a mini-USB port on the wearable device to a USB device on a computer, or the like. The connecting members on the wearable device and the remote device or for charging the batteries are not limited to any particular type of connector interface for a wired connection.

Data collected by the inertial sensor may be recorded and stored along with data relating to the therapeutic vibrations provided by the wearable device. The collected data may then be analyzed to determine effectiveness of the wearable device and to adjust variables (e.g. amplitude, pulse frequency, vibration frequency, zones or vibration motors activated/inactivated, time engaged in active pulsing vs. resting, etc.) of the vibration patterns to maximize effectiveness. The gathered data may be evaluated using machine learning or artificial intelligence to detect patterns and cause/effect. Information or data from other sources may also be integrated into the algorithm for optimizing effectiveness of the device, such as time of day data (to determine if time of day is relevant to involuntary muscle movements), sleep data (to determine if sleeping patterns have an effect on involuntary muscle movements activity), nutritional intake data, body structure data (height, weight, BMI, limb dimensions, etc.) and the like. The additional data and/or the collected data from the wearable device may be confined to the user of the device, or raw data may be pooled (without violating patient data privacy) from multiple users for evaluation of the data by the machine learning algorithm for determining potential patterns between involuntary muscle movements and effectiveness of the wearable devices, based upon a broader survey of information relating to subjects using the device.

In exemplary systems, the microcontroller may be configured to upload data to the remote controller, which is then configured to share that data with a central computer server 180 in the cloud having the substantial processing horsepower typically needed to apply a machine learning algorithm. Data collected by the microcontroller may be transmitted to the server directly from the microcontroller or first to the remote controller and then from the remote controller to the server. The remote controller may also have some limited ability to process and/or store data uploaded from the microcontroller.

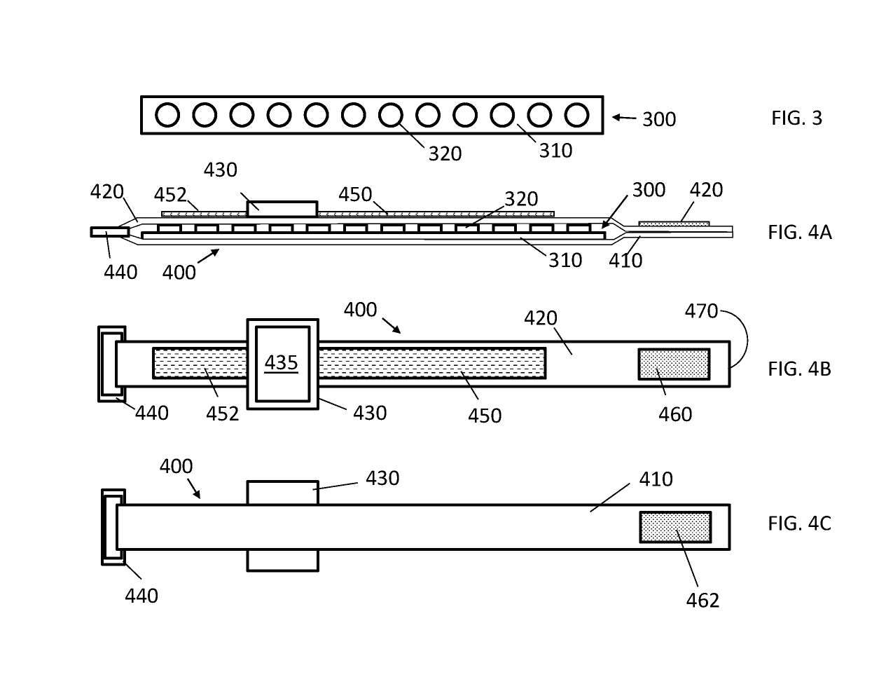

FIGS. 3-4C depict an exemplary wearable device 400. Device 400 is in the form of a band, preferably wearable around a user's arm, preferably around the upper arm (the portion of the arm between the elbow and shoulder) over the bicep and/or tricep. Inside the wearable device is a vibration assembly 300, which may comprise a flexible holder 310 having mounted thereto a plurality of vibration motors 320. In one exemplary embodiment, the flexible holder comprises a NinjaTek® thermoplastic polyurethane (TPU) formed via 3D printing, with twelve coin cell vibration motors mounted thereon. The vibration motors may be glued, sewn, press-fit, or mounted on the flexible holder in any way known in the art. The total number of motors may be any number deemed effective to ensure sufficient transmission of the vibrations to the user to provide the intended benefits. Vibration motors such as those typically used in construction of cell phones for providing haptic signals on vibration mode may be used.

The vibration motors may be commonly connected to a single controller capable of pulsing all of the them on/off together, or the vibration motors may be individually addressable, capable of being pulsed on and off at different frequencies, or one or more, but fewer than all, of the motors may be addressable as a group or zone, with multiple groups therefore being individually controllable. When configured with groups that are individually controllable, the groups may be comprise adjacent motors of different groups (e.g. for the twelve motors in three groups, alternating by group number: 1, 2, 3, 1, 2, 3, 1, 2, 3, 1, 2, 3) or may comprise adjacent motors grouped together (e.g. for the twelve motors grouped in four groups, alternating by group number: 1, 1, 1, 2, 2, 2, 3, 3, 3, 4, 4, 4). Any number of groups (and any number of vibration motors) may be provided.

The wearable device may be configured to permit some of the motors to be turned off. For example, with three groups in an alternating configuration, groups 2 and 3 may be turned off, meaning that a total of four motors evenly spaced about the periphery of the user's arm may be in service. The pulsing may be controllable in rhythms other than an even pulse. For example, individually controllable motors or groups or motors may be pulsed sequentially to provide a sensation of the pulses moving around the arm. The on or off pulses may have a variable amount of duration, and that variable amount can be configured to build (increasing duty cycle) or decline (decreasing duty cycle) gradually, or in patterns (random or defined). For groups in which adjacent sensors are part of a same group, with multiple groups or zones, each zone in a 3 zone system may comprise, for example 33.3% of the circumference of a wearer's arm. It may be found that one or more of those zones is more critical to be vibrated than the others, and therefore the device may be controllable to vibrate the motors in fewer than all zones of the patient's arm. In other embodiments, all zones may be pulsed together. In some embodiments, the distribution of vibrators may not completely cover a full circumference of the user's limb in the location where it is placed, in which case the device may be positioned so that the most critical zones are covered. It is believed that in some embodiments for some patients, the most critical location to be covered comprises the triceps of the patient.

The vibration assembly may be enclosed within top 420 and bottom 410 members, which may be layers of textile, plastic, or the like, configured to enclose the vibration assembly therein. The top and bottom layers may be stitched together, laminated, glued or otherwise affixed together with the vibration assembly enclosed therein. Band 400 is configured to be formed into a loop, such as by threading free end 470 through buckle 400 and then bringing a first connection interface 460 (e.g micro-loops) into contact with a second connection interface 450, 452 (e.g micro-hooks). It should be understood that while described with respect to one configuration, the band may be configured with any means for making it removable and adjustable in diameter within a range of diameters. For example, although depicted as having an open configuration that is closeable into a closed loop configuration, the band may have only a closed loop configuration configured to stretch from a first perimeter value to a second perimeter value, or configured with a clasp that when in a first position contributes to the first perimeter value and in a second position to the second perimeter value, such as is commonly found on certain types of watch bands. Although described with mating micro-loops and micro-hooks (e.g. a Velcro® fastener), the relative location of the micro-loops and micro-hooks as depicted may be reversed. In other embodiments, the adjustability for an open configuration closeable into a loop may be provided by providing one or more pins in the buckle each configured to mate with a hole in the band, such as is commonly found on watchbands. As depicted, the wearable device is configured to permit end 470 to be pulled through buckle 440 and doubled back 180-degrees on itself before mating portion 460 with portion 452, or in another configuration, end 470 may be threaded through buckle (or the buckle may be omitted, or may be removable) and section 462 matted with section 452. Designs may be configured to be useable in both of the forgoing configurations, or only one of the two configurations.

Preferably, regardless of the fastening and/or adjustment mechanisms, band 400 has some degree of elasticity. Such elasticity permits applying the band to the user's arm not only so that the band remains in place, but also so that the band applies some amount of inward radial bias against the body member of the user on which the band is placed. The radial bias may be thus adjustable by changing the resting loop perimeter value (the perimeter measurement of the band in a closed configuration at rest, not on the user's arm), such that when placed on the user's arm and forced to elastically expand to a greater perimeter value, the band provides a desired degree of radial bias as a reaction force to the elastic expansion.

Microcontroller 130 is contained within enclosure 430, which may have a display screen 435. The display screen may be configured to provide an on-board user interface configured to provide user information sufficient to provide basic information and to assist with charging the device. For example, the on board display may be configured to show a display of battery charge capacity in time until recharging is needed or as a percentage of full charge, provide an indication of when the battery is connected to an external power source, information about the current settings of the device (amplitude, frequency, duty cycle, etc.), and/or an indication that the device is paired to the user's computer or otherwise connected to a network or pairable. The microcontroller 130 may further have one or more input buttons (not shown) that permits the user to input information to the microcontroller (such as a yes/no, scrolling function, menu function, and the like, such as are well known in the art for use in watches, fitness monitors, and the like. Some embodiment may have not such local input means, however, and may rely solely on connection to the remote device.

A smart phone configured to connecting to the wearable device may have one or more “apps” that comprises a thin software application connectable to a more robust processor “in the cloud.” The app may comprise a user interface whereby the user can change settings, monitor information, and upload/download new software to the microcontroller. In addition to providing the ability to connect the wearable device to a remote device such as a phone or computer

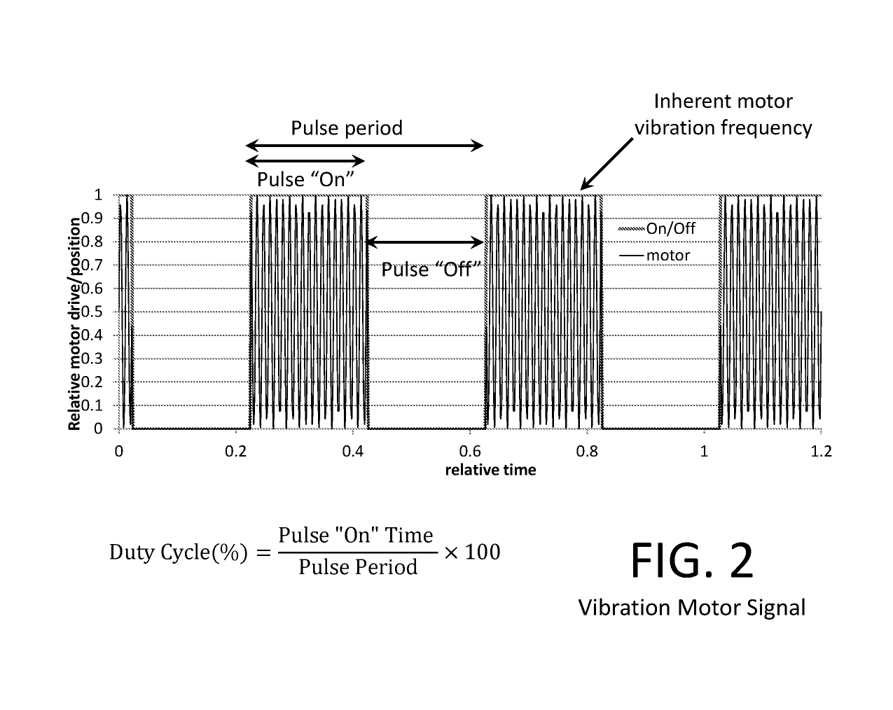

As depicted in FIG. 2, in use, the vibration motors are configured to pulse on and off at a desired rate. Each motor, when on, vibrates at a different rate than the pulse rate. FIG. 2 provides a normalized graph for a given amplitude of 1, for a relative time period of 1 (with both X and Y depicted as dimensionless). As depicted in FIG. 2, the vibration motors have approximately 2 cycles (e.g. one pulse on and one pulse off) per each 0.8 unit of time, with equal on and off times of approximately 0.2 units of time each. Thus, for example, using the formula as depicted in FIG. 2, the duty cycle is 50%. Each pulse-on cycle comprises approximately 19 cycles. The depiction in the graph is for illustration of the concepts of pulse frequency and vibration frequency only, however, and does not necessarily represent expected ranges of operation. For example, with respect to the examples discussed below, an 80 Hz pulse frequency using a 9000 rpm (150 Hz) motor would result in a 0.7*1/80=8.75 millisec “on”/3.75 “off” cycle, which gives a period for the pulse of 12.5 ms. When the motor is “on” it therefore creates 150*0.00875=1.3125 cycles per each “on” pulse.

Coin cell vibration motors may typically operate at a fixed nominal rated minimum frequency at a fixed voltage. Individual motors may have a range of operating frequencies around the nominal rated minimum frequency of plus or minus 20 percent of the nominal rated minimum frequency, or in some cases, minus 30 percent to plus 50 percent nominal rated minimum frequency. In embodiments of the invention, motors having a fixed vibration frequency may be pulsed to obtain an effective frequency that is different from the fixed frequency. The range of pulse frequency for pulsing the vibration assembly on/off may be in a range of 5 Hz (5 cycles per second) to up to or above the actual fixed vibration frequency of the vibration motors (which as noted above, may be greater than the minimum rated frequency). In one exemplary embodiment, coin cell, eccentric rotating mass (ERM) vibration motors from Jinlong Machinery & Electronics Co., Ltd. were used having a nominal rated minimum vibration frequency of 9000 rpm (150 Hz) (minus 30/plus 50 percent) rated for a DC voltage of 1.3 V and a current of 100 mA Max (minus 30/plus 50 percent) and a displacement (amplitude) of 1.5 mm. As is known in the art, increasing or decreasing the current to the motor (i.e. by increasing or decreasing the voltage) may respectively increase or decrease both the amplitude and the frequency of vibration of the motor. Thus, assuming a vibration frequency range of 105-225 Hz, preferable pulse frequencies in a range of 50-160 Hz, the ratio of vibration frequency to pulse may typically fall in a range of 0.65-4.5, or more preferably in a range of 0.8-3, and even more preferably in a range of 0.9 to 2.

Preferably, the device is configured to be affixed to a user's arm in a location above the wrist (e.g. closer to the user's shoulder relative to the wrist). The wearable device is preferably configured to be affixed around the biceps and/or triceps of a user. While the device may be configured to mounted anywhere on a user's arm, it has been found that the biceps and/or triceps have advantages over a user's wrist. Some benefits may also be found by mounting the device on a user's forearm (the portion of the arm between the wrist and the elbow).

Although described herein with respect to an arm of a user, it should be understood that the general methods and apparatus as described herein may also be applied to a leg. As with the arm, it may be more beneficial to control the involuntary muscle movements in a foot by placing the wearable device on the leg in a location between the ankle and the knee (the lower leg), or even above the knee (the upper leg).

### Examples

The co-inventors conducted a first experiment using a prototype band on a Parkinson's patient varying the frequency first to see what affect it would have on hand tremor. This prototype was a “tethered” device, meaning that it was plugged into an electrical outlet. The prototype device comprised 3 vibration generating motors and was first positioned on the wrist on the patient. A pulse frequency of 20 Hz was found to have no effect. Pulse frequencies of 50 Hz, 60 Hz, 80 Hz, and others, with placement on the wrist, had little, if any, effect on the tremor. The device was then positioned above the elbow and the frequency sequence was run again. 60 Hz was found to have the best results, with tremor completely eliminated when the 3 vibrators were placed at the back of the arm above the elbow. The hand tremor completely disappeared and remained absent for the 5 min that the prototype band was vibrating at 60 Hz. The band was then left in position with the vibration shut off. The tremor began again after 2 minutes, showing a surprising residual effect of the vibration on controlling the tremor.

A second experiment was conducted with an untethered (battery-powered) prototype, and the ideal placement on the upper arm was found to be 2″ above the elbow with, again, an optimum frequency of 59-60 Hz.

A third experiment was conducted using a prototype with 3 sets of 3 vibration generating motors positioned around the arm of a Parkinson's patient. Initial testing showed a vibration of time of 5 minutes would stop the hand tremor for up to 2 minutes after the band was turned off (thus achieving efficacy for a duration of 7 minutes with a duration of applied vibration of 5 minutes). Subsequent testing has found subjects for which a 20 minute run time of the wearable device in a vibration mode was followed by 20 minutes with the device in a resting, non-vibration mode without tremors returning. Thus, ratios of on time to off time of 1:1 to 5:2 (applied vibration to efficacy duration of 1:2 (50% applied vibration duration (AVD) as a percentage of efficacy duration (ED)) and 5:7 (71% AVD as a percentage of ED), respectively) were demonstrated as being effective for elimination of tremors.

A prototype device was used by the subject for a period of approximately a month, during which the subjected reported (using a journal) that the tremor could be stopped anywhere from 1.0-3.5 hours while wearing the band without taking any Parkinson's medication. During the testing, pulse frequency was varied from 50 Hz to 115 Hz, with a 55%-80% duty cycle. Table A below presents exemplary findings.

TABLE A

| | | | | | | Ratio of |
|---|---|---|---|---|---|---|
| | | Resting Duration | | | | AVD/ED |
| Applied Vibration | | before reappearance | | Total Efficacy | | (AVD as % |
| (AVD) Duration | | of tremors | | Duration (ED) | | of ED) |
| 1 | hour | 3.5 | hours | 4.5 | hours | 2:9 (22%) |
| 1.5 | hours | 2 | hours | 3.5 | hours | 3:7 (43%) |
| 30 | minutes | 20 | minutes | 50 | minutes | 3:5 (80%) |
| 30 | minutes | 60 | minutes | 90 | minutes | 3:9 (33%) |
| 30 | minutes | 50 | minutes | 80 | minutes | 3:8 (38%) |

Thus, in general, use of the prototype demonstrated that the longer the vibration was applied, the longer time before the reappearance of tremors. The combined results with the prototypes showed an applied vibration duration as a percentage of efficacy duration as low as 22% was achievable, with a range of 22-80%, with a majority of the results being 50% or less. The finding that vibration therapy reduced or eliminated hand tremors in the absence of any Parkinson's medication was surprising. While it is expected that results may vary for individual patients, the ability to turn the wearable device vibration off for an extended period of time may be critical to extending battery life, time between charges, and overall size of the device.

Applicant's discovery that the device can be turned off for some period of time with continued effect is important. When coupled with an inertial sensor to detect involuntary movements of the wearer, a patient can set the device to vibrate for a set period of time and then wait for the sensor to detect a return of the tremors before prompting the device to go back into a vibration mode. Thus, for example, a user may find that “normal” best operation requires 20 minutes on and 20 minutes off, but to save power, the device can be placed in a power saving mode in which the time off is stretched as long as possible to enable the device to be usable for longer. This may be particularly advantageous for a user who may be unable to charge the device, but wants to extend battery life as long as possible before the device shuts off entirely. Data taken from the device regarding the amount of time in vibration mode versus time in a non-vibration mode before the sensor prompts it to be turned on again may be used to create a profile for each individual in which the on time and off time are optimized for a normal mode as well as in a power saving mode.

In one embodiment, the microcontroller was fit within an enclosure having outer dimensions of approximately 1″x3.5″x1.5″ attached to a soft elastic arm band. The armband was placed on the user's upper arm over the user's biceps and triceps of an arm affected by tremors. For a user with both arms equally affected, the device was affixed to the user's dominant arm. Once the wearable device was in place, the vibration was set to a desired pulse frequency. In one experiment, the results of using a relatively lower frequency (low 80 Hz) (1.875 nominal vibration rate to pulse rate, assuming 150 Hz nominal vibration frequency) was compared to the results of using a relatively higher frequency 160 Hz (0.973 nominal vibration rate to pulse rate) The duty cycle was set to 70%, which was found to be a duty typically felt by the user.

The vibration assembly may be configured to completely encircle the portion of the limb on which it is to be placed with vibration motors, or the assembly may cover less than a full circumference of the limb. When in operation, the vibration assembly may be configured to run with all zones active, or only certain zones found to be most effective in reducing tremors. Again, as a power saving feature, some zones or actuators may be turned off to provide longer battery life.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A method for mitigating an involuntary muscle movement in a limb of a patient for an efficacy duration, the method comprising applying external vibration in multiple locations distributed about a periphery of an upper arm or forearm of the patient for an applied vibration duration less than the efficacy duration.

2. The method of claim 1, wherein the location is on the upper arm at least 1 inch above an elbow of the patient.

3. The method of claim 1, wherein the step of applying the external vibration comprises providing a vibration having a vibration frequency pulsed at a pulse frequency, wherein the ratio of vibration frequency to pulse frequency is in a range of 0.65-4.5.

4. The method of claim 1, comprising applying the vibration for an applied vibration duration as a percentage of efficacy duration of less than 80%.

5. The method of claim 1, further comprising applying the vibration, discontinuing vibration while monitoring for signs of a return of involuntary muscle movement in the limb, detecting a return of involuntary muscle movements, and again applying the vibration.

6. The method of claim 1, wherein the step of applying the external vibration comprises providing a wearable device having a plurality of vibration generators mounted thereon, and removably affixing the device to the upper arm or forearm of the patient such that the device transmits radial compression to the arm of the patient.

7. The method of claim 6, wherein the wearable device comprises a power source connected to the plurality of vibration generators, a microcontroller configured to control one or more vibration characteristics of the vibration generators, including pulse frequency, an inertial sensor configured to detect the involuntary muscle movement and to provide a signal to the microcontroller, and a communications interface configured to be paired with a remote device for receiving externally communicated control settings for controlling the wearable device, wherein the microcontroller is programmed to energize the plurality of vibration generators for the applied vibration duration and to de-energize the plurality of vibration generators until the inertial sensor provides the signal to the microcontroller signifying detection of the involuntary muscle movement.

8. A wearable device for mitigating an involuntary muscle movement in limb of a patient, the device comprising:
a flexible base configured to be removably affixed to an upper arm or forearm of the patient, the base configured to transmit a radial compressive force to the upper arm or forearm of the patient;
a plurality of vibration generators mounted on or in the base;
a portable power source integrated into the wearable device;
a microcontroller connected to the power source and configured to control one or more characteristics of a vibration generated by the vibration generators, including causing at least selected vibration generators to pulse on and pulse off at a pulse frequency for an applied vibration duration and to discontinue pulsing on and off for a resting duration, the applied vibration and the resting duration together defining an efficacy duration; and
a communications interface configured to facilitate communications between the microcontroller and a remote controller, the microcontroller configured to receive control settings from the remote controller.

9. The wearable device of claim 8, wherein the portable power source is rechargeable, and the wearable device further comprises an interface for charging the power source.

10. The wearable device of claim 8, wherein the base has an open configuration and a closed configuration, wherein the base has an adjustable periphery in the closed configuration, the base having a first connection interface on a first end configured to mate with a second connection interface on the second end.

11. The wearable device of claim 8, wherein the plurality of vibration generators are distributed on a flexible substrate embedded in the flexible base.

12. The wearable device of claim 8, wherein the plurality of vibration generators are evenly distributed in fixed positions, the selected vibration generators comprise fewer than all of the vibration generators, and the microcontroller is configurable to pulse only the selected vibration generators and not to pulse vibration generators other than the selected vibration generators.

13. The wearable device of claim 12, further comprising an inertial sensor configured to sense involuntary muscle movements in the wearer's arm not caused by the wearable device, wherein the microprocessor is configured to receive and interpret a signal from the inertial sensor and to initiate the vibration assembly in response to the inertial sensor sensing such involuntary muscle movements.

14. The wearable device of claim 12, wherein the vibration generators have a nominal vibration frequency that is different than the pulse frequency, wherein the ratio of vibration frequency to pulse frequency is in a range of 0.65-4.5.

15. The wearable device of claim 12, wherein the microprocessor is configured to apply the vibration for an applied vibration duration as a percentage of efficacy duration of less than 80%.

16. A system configured to mitigate an involuntary muscle movement in limb of a patient, the system comprising the device of claim 12 and the remote controller configured to communicate with the communications interface of the wearable device.

17. The system of claim 16, wherein the remote controller comprises a computer processor programmed with instructions for communicating with the communications interface of the wearable device.

18. The system of claim 17, wherein the system further comprises a central computer having a processor and associated memory and accessible over a global computer network, and the remote controller is configured to communicate with the central computer.

19. The system of claim 18, wherein the wearable device is configured to collect data and to upload the collected data to the remote controller or to the central computer processor, wherein the remote controller, the central computer processor, or a combination thereof is configured to process and store the uploaded data.

20. The system of claim 19, wherein the system is configured to provide control settings to the microcontroller corresponding to optimized operating parameters calculated by the remote controller, the central computer processor, or a combination thereof based upon the uploaded data.
